(19) United States
(12) Patent Application Publication
(10) Pub. No.: US 2025/0016404 A1
(43) Pub. Date: Jan. 9, 2025

(54) Use of Audio Classification as Basis to Control Audio Identification

(71) Applicant: The Nielsen Company (US), LLC, New York, NY (US)

(72) Inventors: Zafar Rafii, Berkeley, CA (US); Robert Coover, Orinda, CA (US); David Gish, Riverdale, NJ (US); Alexander Topchy, Oldsmar, FL (US); Christen V. Nielsen, Dunedin, FL (US); Sadhana Gupta, Columbia, MD (US); Girish Khavasi, New York, NY (US); John Steven Stavropoulos, Edison, NJ (US)

(21) Appl. No.: 18/348,202

(22) Filed: Jul. 6, 2023

(51) Int. Cl. H04N 21/439; H04N 21/422; H04N 21/8358

(52) U.S. Cl. CPC H04N 21/4394; H04N 21/42203; H04N 21/8358

(57) ABSTRACT

A method includes receiving, into a microphone of a portable computing device, audio from a surrounding environment of the portable computing device. The method also includes classifying, by the portable computing device, the received audio as containing media content or as containing no media content. Classifying the received audio as containing media content or as containing no media content comprises determining whether the audio defines content emitted from a media player in the surrounding environment of the portable computing device. The method further includes, based on the classifying, controlling by the portable computing device whether to engage in an audio-identification process for determining an identity of the media content.

### USAGE AND TERMINOLOGY

In this disclosure, unless otherwise specified and/or unless the particular context clearly dictates otherwise, the terms “a” or “an” mean at least one, and the term “the” means the at least one.

In this disclosure, the term “computing system” means a system that includes at least one computing device. In some instances, a computing system can include one or more other computing systems.

### BACKGROUND

In various scenarios, a content distribution system can transmit content to one or more content-presentation devices, which can receive and output the content for presentation to an end-user. Further, such a content distribution system can transmit content in various ways and in various forms. For instance, a content distribution system can transmit content in the form of an analog or digital broadcast stream representing the content.

### SUMMARY

In one aspect, a method to control audio identification is provided. The method includes receiving, into a microphone of a portable computing device, audio from a surrounding environment of the portable computing device. The method also includes classifying, by the portable computing device, the received audio as containing media content or as containing no media content, where classifying the received audio as containing media content or as containing no media content comprises determining whether the audio defines content emitted from a media player in the surrounding environment of the portable computing device. The method further includes based on the classifying, controlling by the portable computing device whether to engage in an audio-identification process for determining an identity of the media content, wherein the controlling includes (i) if the portable computing device classifies the received audio as containing media content rather than as containing no media content, then engaging in the audio-identification process for determining the identity of the media content, and (ii) if the portable computing device classifies the received audio as containing no media content rather than as containing media content, then forgoing from engaging in the audio-identification process for determining the identity of the received audio.

In another aspect, a non-transitory computer-readable storage medium has stored thereon program instructions that, upon execution by a processor of a portable computing device, cause performance of a set of operations. The set of operations includes receiving, into a microphone of a portable computing device, audio from a surrounding environment of the portable computing device. The set of operations also includes classifying, by the portable computing device, the received audio as containing media content or as containing no media content, where classifying the received audio as containing media content or as containing no media content comprises determining whether the audio defines content emitted from a media player in the surrounding environment of the portable computing device. The set of operations further include, based on the classifying, controlling by the portable computing device whether to engage in an audio-identification process for determining an identity of the media content, where the controlling includes (i) if the portable computing device classifies the received audio as containing media content rather than as containing no media content, then engaging in the audio-identification process for determining the identity of the media content, and (ii) if the portable computing device classifies the received audio as containing no media content rather than as containing media content, then forgoing from engaging in the audio-identification process for determining the identity of the received audio.

In a further aspect, a portable computing device is provided. The portable computing device comprises a microphone, a processor, and a non-transitory computer-readable storage medium, having stored thereon program instructions that, upon execution by the processor, cause performance of a set of operations. The set of operations includes receiving, into the microphone of the portable computing device, audio from a surrounding environment of the portable computing device. The set of operations also includes classifying, by the portable computing device, the received audio as containing media content or as containing no media content, where classifying the received audio as containing media content or as containing no media content comprises determining whether the audio defines content emitted from a media player in the surrounding environment of the portable computing device. The set of operations further include, based on the classifying, controlling by the portable computing device whether to engage in an audio-identification process for determining an identity of the media content, where the controlling includes (i) if the portable computing device classifies the received audio as containing media content rather than as containing no media content, then engaging in the audio-identification process for determining the identity of the media content, and (ii) if the portable computing device classifies the received audio as containing no media content rather than as containing media content, then forgoing from engaging in the audio-identification process for determining the identity of the received audio.

### BRIEF DESCRIPTION OF THE DRAWINGS

FIG. 1 is a simplified block diagram of an example content-modification system in which various described principles can be implemented.

FIG. 2 is a simplified block diagram of an example computing system in which various described principles can be implemented.

FIG. 3 is a simplified block diagram of a process of controlling audio identification.

FIG. 4 is a simplified block diagram of a classification module.

FIG. 5 is a flow chart illustrating an example method.

### DETAILED DESCRIPTION

### I. Overview

A user may watch television, stream movies, listen to music, tune into radio, and/or consume other types of content using one or more media presentation devices. Each media presentation device may output television shows, movies, videos, music, and scheduled advertising, among other media content. In some situations, it may be useful to collect statistics regarding what media content the user is consuming and regarding what the user's response is to media content being emitted by the media presentation devices, perhaps in order to recommend media content and replace various scheduled advertisements with targeted advertisements, among other possible actions.

To facilitate collecting such data across multiple media presentation devices, a portable and/or wearable computing device may be used to collect ambient audio including audio emitted by the media presentation devices. A user may carry the portable computing device to various locations in the user's environment as the user consumes the content from the various media presentation devices. The computing device may record ambient audio, which may include ambient environment noises, periods of silence, and audio being emitted by one of the media presentation devices. Based on the collected ambient audio, the computing device may engage in an audio-identification process to identify the content that the user is consuming, which may include the content being output from one of the various media presentation devices, such as television shows, movies, videos, songs, and/or advertisements, among other examples. The computing device may then use the determined identity of the content as a basis to recommend content, cause the replacement various scheduled advertisements, and/or take other actions corresponding to the identification of the content.

In an effort to identify content in the environment, the computing device may constantly collect and engage in an audio-identification process. However, constantly or frequently running an audio-identification process may drain computing resources of the computing device, thereby resulting in the computing device consuming more energy and/or having a shorter battery life, due to the computationally expensive nature of the audio-identification process. Therefore, it may be useful to execute the audio-identification process just when the ambient audio includes content being presented by at least one media presentation device and to forgo executing the audio-identification process when the ambient audio does not include content being presented by any media presentation device.

Provided herein are methods to determine whether to engage in audio-identification processes for various ambient audio. In a representative method, the computing device may be a portable computing device that a user may carry around from place to place, and the portable computing device may monitor ambient audio in the user's surrounding environment to determine when the device should engage in audio-identification processing and when the device should forgo engaging in audio-identification processing.

To facilitate this, the computing device may receive and/or analyze audio from a surrounding environment of the device. For example, the computing device may include a microphone through which the computing device may receive audio, and the computing device may periodically or continuously monitor the audio of the surrounding environment of the computing device.

As the computing device receives audio of the environment, the computing device may classify the received audio as containing media content or as containing no media content. In some examples, audio containing media content may include content that is output by a media player in the environment, whereas containing no media content may be content that is not output by a media player in the surrounding environment. Media content may include sounds output by a phone, audio associated with a movie being output by a television, and/or music output by a radio, among other examples. In contrast, audio containing no media content may include the sounds of shuffling paper, water running, and snoring, among other examples.

The computing device may classify the received audio by applying a trained machine-learning model. The trained machine-learning model may include one or more weights used to predict whether audio content contains media content or does not contain media content. The values of the weights may be determined through back-propagation to update initially-set values or updated values such that the machine-learning model may accurately predict whether audio content contains media content or does not contain media content.

To apply the trained machine-learning model, the computing device may determine at least one audio property of the received audio and, based on the at least one audio property, may determine at least one statistical measure of the determined audio property for input into the trained machine-learning model. Audio properties may include one or more spectrograms, signal-to-noise ratios, and/or sound pressure measurements, among other examples. Based on these audio properties, the computing device may determine statistical measurements such as mean, standard deviation, skewness, and/or kurtosis, among other examples. The computing device may then input the computed statistical quantities into the machine-learning model to determine whether the audio contains media content or does not contain media content.

For example, a computing device may receive and record audio from its environment. Based on the recorded audio, the computing device may then determine an equivalent rectangular bandwidth (ERB) spectrogram or other type of spectrogram. In some examples, the ERB spectrogram may be more compact than other spectrograms, which may facilitate quick and efficient predictions. The computing device may take a particular window of the spectrogram (e.g., 6 seconds), and the computing device may determine the mean, standard deviation, skewness, kurtosis, and other statistics of the data within that window of the spectrogram. Further, the computing device may repeat determining the mean, standard deviation, skewness, kurtosis, and other statistics of data within other subsequent windows of the spectrogram (possibly on a sliding window basis). In addition, the computing device may apply a similar process for the other audio properties (e.g., the signal-to-noise ratio, the sound pressure measurements, etc.) to determine associated statistics. Having determined these statistics, the computing device may then input the statistics into the trained machine-learning model to obtain a prediction of whether the audio represented by the input contains media content or rather does not contain media content.

Based on this ongoing classifying of whether the audio contains media content, the computing device may control whether the computing device carries out an audio-identification process to determine the identity of the media content that might be included in the received audio. For instance, at times when the computing device so classifies the audio as containing media content, the computing device may carry out the audio-identification process in an effort to identify the media content. Engaging in the audio-identification process for determining the identity of the received audio may include searching in the received audio for watermarking that encodes an identifier of the media content or generating digital fingerprint data representing the received audio to be compared with reference digital fingerprint data of known audio. In contrast, at times when the computing device so classifies the audio as not containing audio content, the computing device may forgo carrying out of the audio-identification process, possibly thereby conserving processing and power resources.

As mentioned above, determining the identity of the received audio may help facilitate content modification, user behavior measurements, and/or other operations. In particular, analyzing audio from a surrounding environment of the device to identify the media content being presented in the surrounding environment of the device may allow for statistics on what media content the user is being presented to the user and how the user reacts to the media content being presented (e.g., if the user continues watching or stops watching a particular media content), among other statistics. A content-presentation device or other computing device may use these statistics to determine what media content to suggest to the user, and which advertisements to use to replace scheduled advertisements, among other examples.

### II. Architecture

### A. Content-Modification System

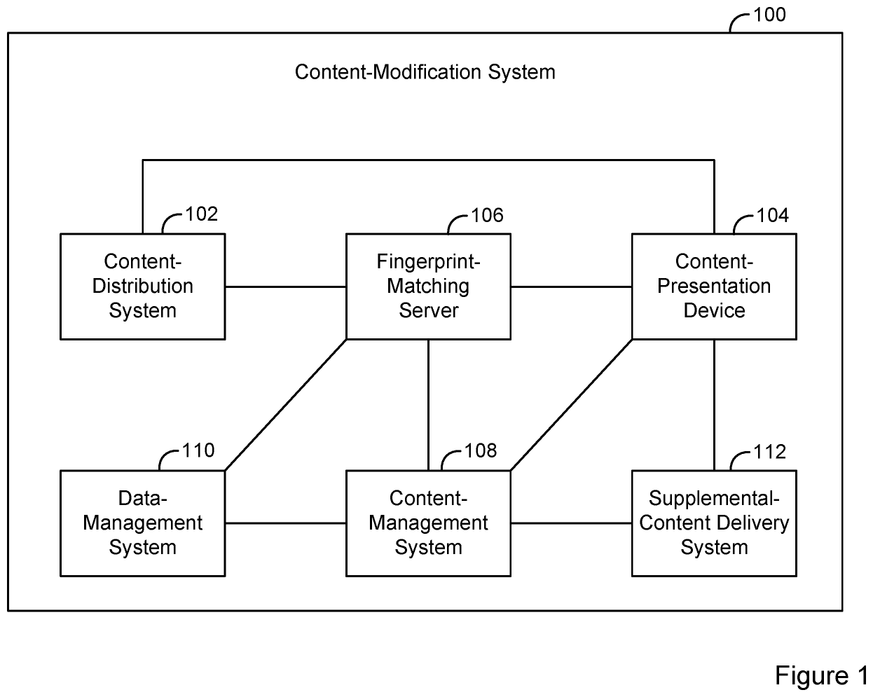

FIG. 1 is a simplified block diagram of an example content-modification system 100. The content-modification system 100 can include various components, such as a content-distribution system 102, a content-presentation device 104, a fingerprint-matching server 106, a content-management system 108, a data-management system 110, and/or a supplemental-content delivery system 112.

The content-modification system 100 can also include one or more connection mechanisms that connect various components within the content-modification system 100. For example, the content-modification system 100 can include the connection mechanisms represented by lines connecting components of the content-modification system 100, as shown in FIG. 1.

In this disclosure, the term “connection mechanism” means a mechanism that connects and facilitates communication between two or more components, devices, systems, or other entities. A connection mechanism can be or include a relatively simple mechanism, such as a cable or system bus, and/or a relatively complex mechanism, such as a packet-based communication network (e.g., the Internet). In some instances, a connection mechanism can be or include a non-tangible medium, such as in the case where the connection is at least partially wireless. A connection can be a direct connection or an indirect connection, the latter being a connection that passes through and/or traverses one or more entities, such as a router, switcher, or other network device. Further, communication (e.g., a transmission or receipt of data) can be a direct or indirect communication.

The content-modification system 100 and/or components thereof can take the form of a computing system, an example of which is described below. Further, the content-modification system 100 may include many instances of at least some of the described components. For example, the content-modification system 100 may include many content-distribution systems and many content-presentation devices.

### B. Computing System

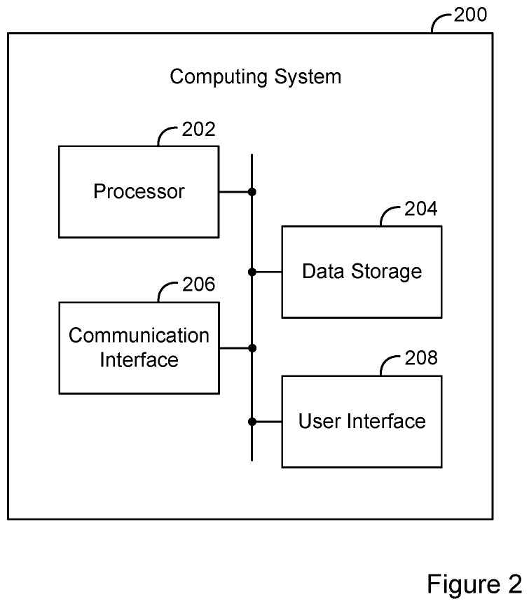

FIG. 2 is a simplified block diagram of an example computing system 200. The computing system 200 can be configured to perform and/or can perform one or more operations, such as the operations described in this disclosure. The computing system 200 can include various components, such as a processor 202, a data-storage unit 204, a communication interface 206, and/or a user interface 208.

The processor 202 can be or include a general-purpose processor (e.g., a microprocessor) and/or a special-purpose processor (e.g., a digital signal processor). The processor 202 can execute program instructions included in the data-storage 204 as described below.

The data storage 204 can be or include one or more volatile, non-volatile, removable, and/or non-removable storage components, such as magnetic, optical, and/or flash storage, and/or can be integrated in whole or in part with the processor 202. Further, the data storage 204 can be or include a non-transitory computer-readable storage medium, having stored thereon program instructions (e.g., compiled or non-compiled program logic and/or machine code) that, upon execution by the processor 202, cause the computing system 200 and/or another computing system to perform one or more operations, such as the operations described in this disclosure. These program instructions can define, and/or be part of, a discrete software application.

In some instances, the computing system 200 can execute program instructions in response to receiving an input, such as an input received via the communication interface 206 and/or the user interface 208. The data storage 204 can also store other data, such as any of the data described in this disclosure.

The communication interface 206 can allow the computing system 200 to connect with and/or communicate with another entity according to one or more protocols. Therefore, the computing system 200 can transmit data to, and/or receive data from, one or more other entities according to one or more protocols. In one example, the communication interface 206 can be or include a wired interface, such as an Ethernet interface or a High-Definition Multimedia Interface (HDMI). In another example, the communication interface 206 can be or include a wireless interface, such as a cellular or WI-FI interface.

The user interface 208 can allow for interaction between the computing system 200 and a user of the computing system 200. As such, the user interface 208 can be or include one or more input components such as a keyboard, a mouse, a remote controller, a microphone, and/or a touch-sensitive panel. The user interface 208 can also be or include one or more output components such as a display device (which, for example, can be combined with a touch-sensitive panel) and/or a sound speaker.

The computing system 200 can also include one or more connection mechanisms that connect various components within the computing system 200. For example, the computing system 200 can include the connection mechanisms represented by lines that connect components of the computing system 200, as shown in FIG. 2.

The computing system 200 can include one or more of the above-described components and can be configured or arranged in various ways. For example, the computing system 200 can be configured as a server and/or a client (or perhaps a cluster of servers and/or a cluster of clients) operating in one or more server-client type arrangements, for instance.

As noted above, the content-modification system 100 and/or components thereof can take the form of a computing system, an example of which could be the computing system 200. In some cases, some or all these entities can take the form of a more specific type of computing system. For instance, the content-presentation device 104 may take the form of a desktop computer, a laptop, a tablet, a mobile phone, a television set, a set-top box, a television set with an integrated set-top box, a media dongle, or a television set with a media dongle connected to it, among other possibilities.

### III. Example Operations

The content-modification system 100 and/or components thereof can be configured to perform and/or can perform one or more operations. Examples of these operations and related features will now be described.

As noted above, in practice, the content-modification system 100 is likely to include many instances of at least some of the described components. Likewise, in practice, it is likely that at least some of described operations will be performed many times (perhaps on a routine basis and/or in connection with additional instances of the described components).

### A. Operations Related to the Content-Distribution System Transmitting Content and the Content-Presenting Device Receiving and Outputting Content

For context, examples of general operations related to the content-distribution system 102 transmitting content and the content-presentation device 104 receiving and outputting content will now be described.

To begin, the content-distribution system 102 can transmit content (e.g., content that the content-distribution system 102 received from a content provider) to one or more entities such as the content-presentation device 104. Content can be or include audio content and/or video content, among other possibilities. In some examples, content can take the form of a linear sequence of content segments (e.g., program segments and/or advertisement segments) or a portion thereof. In the case of video content, a portion of the video content may be one or more video frames and another portion may be one or more audio frames defining an audio track, for example.

The content-distribution system 102 can transmit content on one or more channels (sometimes referred to as stations or feeds). As such, the content-distribution system 102 can be associated with a single-channel content distributor or a multi-channel content distributor such as a multi-channel video program distributor (MVPD).

The content-distribution system 102 and its means of transmission of content on the channel to the content-presentation device 104 can take various forms. By way of example, the content-distribution system 102 can be or include a cable-television head-end that is associated with a cable-television provider and that transmits the content on the channel to the content-presentation device 104 through hybrid fiber/coaxial cable connections. As another example, the content-distribution system 102 can be or include a satellite-television head-end that is associated with a satellite-television provider and that transmits the content on the channel to the content-presentation device 104 through a satellite transmission. As yet another example, the content-distribution system 102 can be or include a television-broadcast station that is associated with a television-broadcast provider and that transmits the content on the channel through a terrestrial over-the-air interface to the content-presentation device 104. In these and other examples, the content-distribution system 102 can transmit the content in the form of an analog or digital broadcast stream representing the content.

The content-presentation device 104 can receive content from one or more entities, such as the content-distribution system 102. In one example, the content-presentation device 104 can select (e.g., by tuning to) a channel from among multiple available channels, perhaps based on input received via a user interface, such that the content-presentation device 104 can receive content on the selected channel.

In some examples, the content-distribution system 102 can transmit content to the content-presentation device 104, which the content-presentation device 104 can receive, and therefore the transmitted content and the received content can be the same. However, in other examples, they can be different, such as where the content-distribution system 102 transmits content to the content-presentation device 104, but the content-presentation device 104 does not receive the content and instead receives different content from a different content-distribution system.

The content-presentation device 104 can also output content for presentation. As noted above, the content-presentation device 104 can take various forms. In one example, in the case where the content-presentation device 104 is a television set (perhaps with an integrated set-top box and/or media dongle), outputting the content for presentation can involve the television set outputting the content via a user interface (e.g., a display device and/or a sound speaker), such that it can be presented to an end-user. As another example, in the case where the content-presentation device 104 is a set-top box or a media dongle, outputting the content for presentation can involve the set-top box or the media dongle outputting the content via a communication interface (e.g., an HDMI interface), such that it can be received by a television set and in turn output by the television set for presentation to an end-user.

As such, in various scenarios, the content-distribution system 102 can transmit content to the content-presentation device 104, which can receive and output the content for presentation to an end-user.

In some situations, even though the content-presentation device 104 receives content from the content-distribution system 102, it can be desirable for the content-presentation device 104 to perform a content-modification operation so that the content-presentation device 104 can output for presentation alternative content instead of at least a portion of that received content.

For example, in the case where the content-presentation device 104 receives a linear sequence of content segments that includes a given advertisement segment positioned somewhere within the sequence, it can be desirable for the content-presentation device 104 to replace the given advertisement segment with a different advertisement segment that is perhaps more targeted to the end-user (i.e., more targeted to the end-user's interests, demographics, etc.) As another example, it can be desirable for the content-presentation device 104 to overlay, on the given advertisement segment, content that enhances the given advertisement segment in a way that is again perhaps more targeted to the end-user. The described content-modification system 100 can facilitate providing these and other related features.

### B. Operations Related to Controlling Audio-Identification Processes

In some examples, an environment may include one or more content-presentation devices 104 of content modification system 100 and/or include one or more content-modification systems 100 and/or may include one or more other content-presentation devices even if not part of a content-modification system. Each of the content-presentation devices may output television shows, movies, videos, music, and/or scheduled advertising, among other media content.

As mentioned above, a portable and/or wearable computing device may be used to collect statistics on what media content the user is consuming and on what the user's response is to the media content being presented by the media-presentation devices. In particular, the computing device may engage in an audio-identification process to identify media content that the user is consuming and/or what media content causes the user to change channels, among other examples. Carrying out this audio-identification process may include the computing device performing at least some aspects of the process and possibly triggering another system (e.g., a cloud-based system) to perform other aspects of the process. The collected statistics may be used to recommend media content, determine targeted replacement advertising, and/or replace various scheduled advertisements, among other examples.

However, an issue may arise where the computing device constantly collects and engages in the audio identification processes, perhaps when the content-presentation devices are not presenting any media content in the computing device's environment. As noted above, constantly or frequently running the audio-identification process may drain computing resources of the computing device, resulting in the computing device having a shorter battery life and/or slower response time, due to the computationally expensive nature of the audio-identification process. It may therefore be useful for the computing device to intelligently control when to engage in that process. In particular, it may be useful for the computing device to engage in a process to control whether to engage in the audio-identification process based on whether audio in the computing device's environment contains media content.

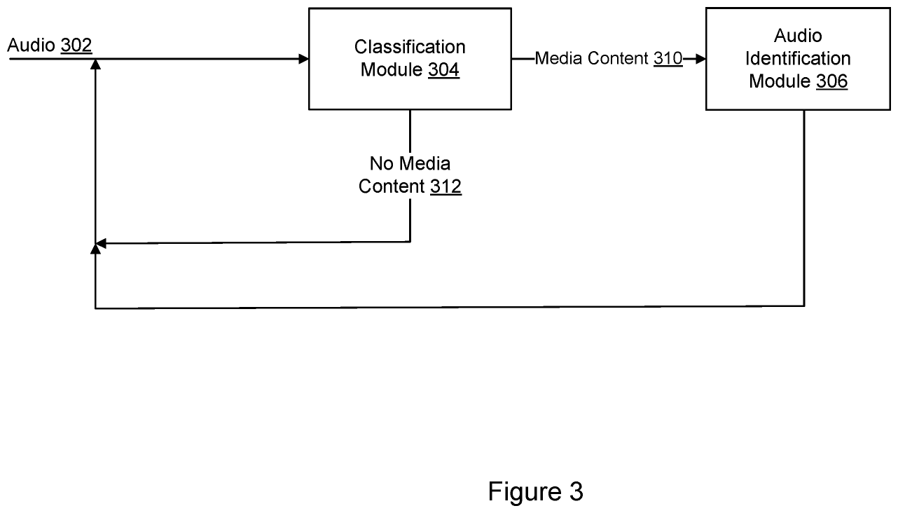

FIG. 3 is a simplified block diagram of an example of such a process of controlling audio identification. The arrangement of FIG. 3 begins with a portable and/or wearable computing device receiving audio 302, perhaps through a microphone of the computing device. The audio 302 may include signals of sounds output by a media-presentation device, sounds output by a phone, audio associated with a movie being output by a television, music output by a radio, shuffling paper, water running, and snoring, among other examples.

As the computing device receives this audio 302, the computing device may then feed the audio 302 into a classification module 304 of the computing device 304, which may output an indication (e.g., prediction) of whether the audio 302 contains any media content 310 or rather whether the audio 302 contains no media content 312. For instance, by applying this classification module, the computing device may classify audio that includes sounds output by a phone or media-presentation device, audio associated with a movie being output by a television, and/or music output by a radio, among other examples as audio containing media content 310. In contrast, the computing device may classify audio that does not include such sounds (e.g., audio that includes merely sounds of shuffling paper, water running, and snoring, among other examples) as audio containing no media content 312.

If the computing device determines by applying this or another such classifier that the audio 302 contains media content, then at step 310, based at least in part on that determination, the computing device may proceed to apply an audio-identification module 306 of the computing device. Applying the audio-identification module 306, the computing device may determine an identity of the audio 302 (e.g., an identity of the media content contained in the audio 302), perhaps by sending the audio 302 to another device or system for identification. Further, the computing system may store the determined identity of the audio 302 and/or send the determined identity of the audio 302 to another computing device for storage, perhaps so that the identity of the audio may be used as a basis to determine replacement media content as discussed above and/or for other purposes.

Whereas, if the computing device determines by applying this or another such classifier that the audio 302 does not contain media content, then at step 312, based at least in part on that determination, the computing device may forgo applying the audio-identification module 306 to identify the audio 302. Namely, in that situation, the computing device might take no action in response to the received audio content.

In some examples, determining whether the audio contains content may involve inaccurately classifying audio that includes media content as not containing media content and/or inaccurately classifying audio that does not include media content as containing media content. If the computing device inaccurately classifies the audio, the computing system may carry out operations in accordance with the inaccurate classification. For instance, if the computing device inaccurately classifies audio content containing no media content as containing media content, the computing device may proceed to apply the audio-identification module 306. Whereas, if the computing device inaccurately classifies audio content containing media content as containing no media content, the computing device may forgo applying the audio-identification module 306.

The computing device may continue this process over time. Namely, the computing device may continue to collect further audio, classify the collected further audio as containing media content or not containing media content, and, at times when the computing device classifies the further audio as containing media content, apply the audio-identification module 306 to identify the further audio.

In some examples, to classify the audio 302 as containing media content or as not containing media content, the computing device may determine at least one statistical measure of at least one audio property. Determining at least one statistical measure for at least one audio property may facilitate a fast determination of whether the audio includes media content or does not include media content, as the at least one statistical measure for at least one audio property may condense the audio to emphasize various defining characteristics of the audio. The audio properties may include a spectrogram, a signal-to-noise ratio, and a sound pressure measurement. The at least one statistical measure may include the mean, standard deviation, skewness, kurtosis, and other statistics of the respective audio property segment. The computing device may input the at least one statistical measure of the at least one audio property into a trained machine-learning model to determine a classification. The classification may be a binary classification and/or probability measure indicating whether the audio 302 contains media content or does not contain media content.

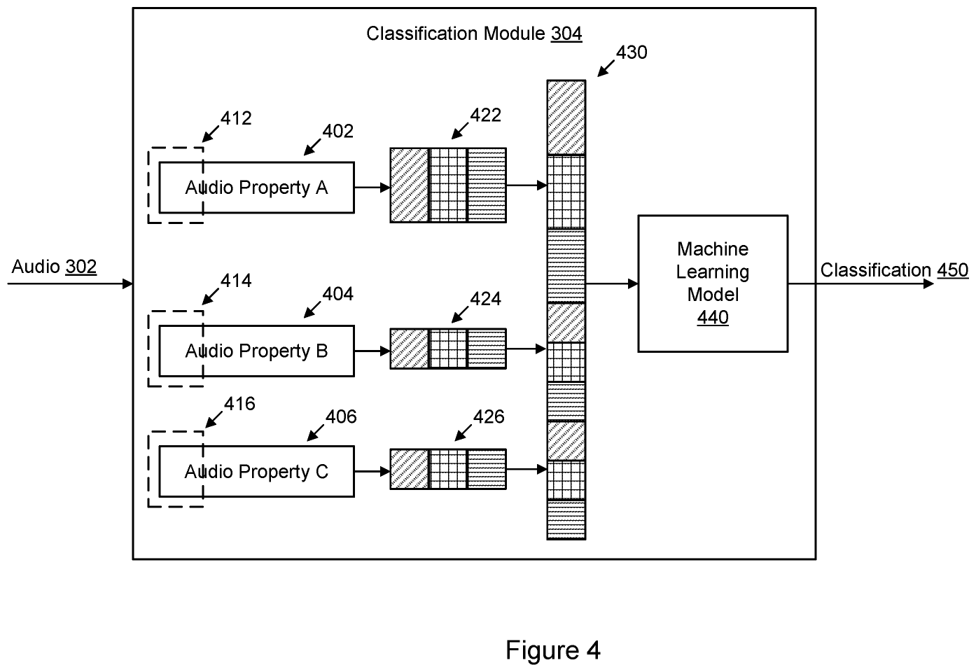

FIG. 4 is a simplified block diagram of an example classification module 304. The classification module 304 may include program instructions executable to carry out operations to classify the audio 302 as containing media content or as not containing media content and may provide a resulting classification 450. In some examples, the classification module may define all of these operations itself. In other examples, the classification module may outsource some of these operations to an external system such as a cloud-based system for instance.

In an example of the classification process, the computing device may determine one or more audio properties of the audio 302, including an audio property A 402, an audio property B 404, and/or an audio property C 406. These audio properties may represent one or more characteristics of the audio 302. For instance, audio property A 402 may be an equivalent rectangular bandwidth (ERB) spectrogram or another type of spectrogram of the audio 302. In some examples, the ERB spectrum may be more compact than other spectrograms, which may therefore facilitate quick and efficient predictions. The computing device may determine the spectrogram by computing a Fourier transform, a discrete cosine transform, a modified discrete cosine transform, a wavelet transform, or other signal transformation that allows for extraction of frequencies present in the audio. As another example, audio property B 404 may be a signal-to-noise ratio, and the audio property C 406 may be sound pressure measurements. Other audio properties in addition to and/or as an alternative to audio property A 402, audio property B 404, and/or audio property C 406 may also be possible.

Based on the determined audio property A 402, audio property B 404, and/or audio property C 406, the computing device may determine statistical measures 422 of audio property A 402, statistical measures 424 of audio property B 404, and statistical measures 426 of audio property C 406. The audio properties may include various data as a function of time, and the computing device may determine the statistical measures 422, 424, and 426 based on a segment of the audio properties such that a segment of an audio property includes a portion of the audio property within a threshold amount of time. For instance, the computing device may determine the statistical measures 422 from a segment 412 of audio property A, which may include 10 seconds of the ERB spectrogram. The computing device may determine the statistical measures 424 from a segment 414 of audio property B, which may include 10 seconds of the signal-to-noise ratio. The computing device may determine the statistical measures 426 from a segment 416 of audio property C, which may include 10 seconds of the sound pressure measurements.

The statistical measures 422, 424, and 426 may include the mean, standard deviation, skewness, kurtosis, and other statistics of the respective audio property segment. For instance, the computing device may determine the mean, standard deviation, skewness, and kurtosis of the audio property A segment 412 to determine the statistical measures 422. The computing device may also determine the mean, standard deviation, skewness, and kurtosis of the audio property B segment 414 to determine the statistical measure 424. Further, the computing device ay determine the mean, standard deviation, skewness, and kurtosis of the audio property C segment 416 to determine the statistical measures 426. As mentioned, the computing device may determine one or more other statistics as part of statistical measures 422, 424, and 426 in addition to or as an alternative to the mean, standard deviation, skewness, and kurtosis of the audio property A 402, audio property B 404, and the audio property C 406.

The computing device may then concatenate the determined statistical measures 422, 424, and 426 to determine a statistical summary 430 of the audio 302, and the computing device may input the determined statistical summary 430 into a machine-learning model 440. Concatenating the determined statistical measures 422, 424, and 426 may involve incorporating the statistical measures into a single data structure (e.g., a matrix or an array) such that the data structure includes the statistical measures 422, 424, and 426.

As each of the statistical measures 422, 424, and 426 may include statistical measures of the audio properties, the statistical summary 430 may include and/or augment various characteristics of the audio 302, which may result in a more accurate classification than if the computing device had input the audio 302 directly into the machine learning model 440. For instance, the statistical measure may be a mean and the audio property may be a spectrogram. Taking the mean of the frequencies included in the spectrogram of an audio may result in a characterization of the mean frequency, which may augment the average frequency in the spectrogram. As another example, the statistical measure may be skewness and the audio property may be a signal to noise ratio, which may result in a characterization of the skewness of the signal to noise ratio and augment the distribution of noise in the audio.

Each of the statistical measures 422, 424, and 426 may summarize the audio properties, resulting in the statistical measures may including less information than the audio properties. Due to the statistical measures including less information than the audio properties, executing the machine learning model may take less time and less memory than inputting the audio properties into the machine learning model. The machine learning model 440 may be a pre-trained machine learning model, trained on a dataset of statistical summaries of various audio and classifications corresponding to the respective audio containing media content or the respective audio not containing media content.

By applying the machine learning model 440 to the statistical summary 430, the computing system may determine the classification 450, which may indicate whether the audio 302 contains media content or no media content. Based on the classification 450, the computing system may determine whether to carry out an action corresponding to the audio 302 containing media content or rather an action corresponding to the audio 302 not containing media content.

In particular, if the computing device determines the classification 450 as indicating that the audio 302 includes media content, the computing device may take an action corresponding to the audio 302 including media content. For example, based on that determination, the computing device may carry out an audio-identification process to determine the identity of the audio 302. In some examples, engaging in the audio-identification process for determining the identity of the audio 302 may include searching in the audio 302 for watermarking that encodes an identifier of the media content. Additionally and/or alternatively, engaging in the audio-identification process for determining the identity of the audio 302 may include generating digital fingerprint data representing the audio 302. The computing device may use the generated digital fingerprint data to facilitate automatic content recognition. Based on determined identity of the audio 302, the computing device may measure media exposure and/or otherwise store the identity of or statistics corresponding to the audio 302.

If the computing device determines that the classification 450 as indicating that the audio 302 does not include media content, the computing device may take an action corresponding to the audio 302 not including media content. For example, the computing device may carry out the process described herein with a new audio to determine whether the new audio contains media content or not, rather than the computing device carrying out an audio-identification process to determine the identity of the audio 302.

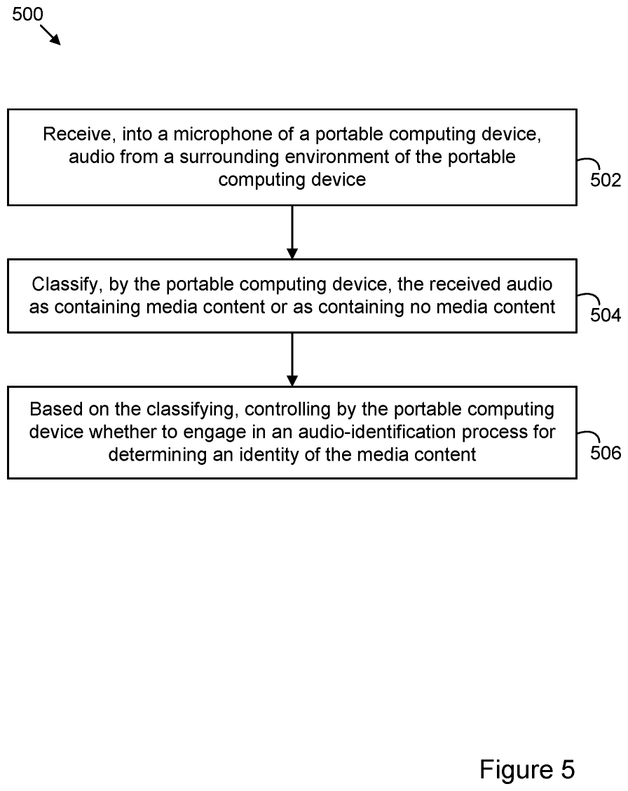

FIG. 5 is a flow chart illustrating an example method 500 to control audio identification. As mentioned above, the example method 500 may be carried out by a computing system or various computing devices within a computing system.

At block 502, method 500 includes receiving, into a microphone of a portable computing device, audio from a surrounding environment of the portable computing device.

At block 504, method 500 includes classifying, by the portable computing device, the received audio as containing media content or as containing no media content, wherein classifying the received audio as containing media content or as containing no media content comprises determining whether the audio defines content emitted from a media player in the surrounding environment of the portable computing device.

At block 506, method 500 includes based on the classifying, controlling by the portable computing device whether to engage in an audio-identification process for determining an identity of the media content. The controlling includes (i) if the portable computing device classifies the received audio as containing media content rather than as containing no media content, then engaging in the audio-identification process for determining the identity of the media content, and (ii) if the portable computing device classifies the received audio as containing no media content rather than as containing media content, then forgoing from engaging in the audio-identification process for determining the identity of the received audio.

In line with the discussion above, engaging in the audio-identification process for determining the identity of the media content could include generating digital fingerprint data representing the received audio. The generated digital fingerprint data could be useable to facilitate automatic content recognition (ACR). Further, engaging in the audio-identification process for determining the identity of the media content could involve searching in the received audio for watermarking that encodes an identifier of the media content. Still further, the audio-identification process facilitates measuring media exposure.

In addition, classifying the received audio as containing media content or containing no media content could involve applying a trained machine-learning model that classifies the received audio as either containing media content or not containing media content.

Further, the method involve training a machine-learning model to establish the trained machine-learning model. For instance, the method could involve training the machine-learning model based on a dataset of a plurality of audio segments and corresponding audio segment labels classifying each corresponding audio segment as containing media content or containing no media content. Training the machine-learning model could involve (i) determining at least one statistical measure of each of at least one audio property of each of the audio segments, (ii) feeding the at least one statistical measure of each of the audio segments to obtain a prediction of each of the plurality of audio segments contains media content or contains no media content, and (iii) updating the machine-learning model based on a comparison of the prediction of each of the plurality of audio segments with the corresponding audio segment labels.

In addition, the training of the machine-learning model could be based on at least one statistical measure of each of at least one audio property, and the applying of the trained machine-learning model could involve (i) determining the at least one statistical measure of each of the at least one audio property of the received audio and (ii) feeding into the trained machine-learning model the determined at least one statistical measure of each of the at least one audio property of the received audio.

In this or other implementations, the at least one audio property could include a property such as a spectrogram, a signal-to-noise ratio, and/or a sound pressure level measurement. Further, the at least one statistical measure could include a statistical measure such as mean, standard deviation, skewness, and/or kurtosis.

As noted above, this method could be carried out by a computing system such as that described above. Further, the present disclosure also contemplates at least one non-transitory computer readable medium (e.g., magnetic, optical, flash, RAM, ROM, EPROM, EEPROM, etc.) that is encoded with, embodies, or otherwise stores program instructions executable by at least one processor to carry out the operations of the method and/or other operations discussed herein.

### IV. Example Variations

Although the examples and features described above have been described in connection with specific entities and specific operations, in practice, there are likely to be many instances of these entities and many instances of these operations being performed, perhaps contemporaneously or simultaneously, on a large-scale basis. Indeed, in practice, the content-modification system 100 is likely to include many content-distribution systems (each potentially transmitting content on many channels) and many content-presentation devices, with some or all of the described operations being performed on a routine and repeating basis in connection with some or all of these entities.

In addition, although some of the operations described in this disclosure have been described as being performed by a particular entity, the operations can be performed by any entity, such as the other entities described in this disclosure. Further, although the operations have been recited in a particular order and/or in connection with example temporal language, the operations need not be performed in the order recited and need not be performed in accordance with any particular temporal restrictions. However, in some instances, it can be desired to perform one or more of the operations in the order recited, in another order, and/or in a manner where at least some of the operations are performed contemporaneously/simultaneously. Likewise, in some instances, it can be desired to perform one or more of the operations in accordance with one more or the recited temporal restrictions or with other timing restrictions. Further, each of the described operations can be performed responsive to performance of one or more of the other described operations. Also, not all of the operations need to be performed to achieve one or more of the benefits provided by the disclosure, and therefore not all of the operations are required.

Although certain variations have been described in connection with one or more examples of this disclosure, these variations can also be applied to some or all of the other examples of this disclosure as well and therefore aspects of this disclosure can be combined and/or arranged in many ways. The examples described in this disclosure were selected at least in part because they help explain the practical application of the various described features.

Also, although select examples of this disclosure have been described, alterations and permutations of these examples will be apparent to those of ordinary skill in the art. Other changes, substitutions, and/or alterations are also possible without departing from the invention in its broader aspects as set forth in the following claims.

What is claimed is:

1. A method to control audio identification, the method comprising:
receiving, into a microphone of a portable computing device, audio from a surrounding environment of the portable computing device;
classifying, by the portable computing device, the received audio as containing media content or as containing no media content, wherein classifying the received audio as containing media content or as containing no media content comprises determining whether the audio defines content emitted from a media player in the surrounding environment of the portable computing device; and
based on the classifying, controlling by the portable computing device whether to engage in an audio-identification process for determining an identity of the media content, wherein the controlling includes (i) if the portable computing device classifies the received audio as containing media content rather than as containing no media content, then engaging in the audio-identification process for determining the identity of the media content, and (ii) if the portable computing device classifies the received audio as containing no media content rather than as containing media content, then forgoing from engaging in the audio-identification process for determining the identity of the received audio.

2. The method of claim 1, wherein engaging in the audio-identification process for determining the identity of the media content comprises generating digital fingerprint data representing the received audio, wherein the generated digital fingerprint data is useable to facilitate automatic content recognition (ACR).

3. The method of claim 1, wherein engaging in the audio-identification process for determining the identity of the media content comprises searching in the received audio for watermarking that encodes an identifier of the media content.

4. The method of claim 1, wherein the audio-identification process facilitates measuring media exposure.

5. The method of claim 1, wherein classifying the received audio as containing media content or containing no media content comprises applying a trained machine-learning model that classifies the received audio as containing either media content or not containing media content.

6. The method of claim 5, wherein the method further comprises training a machine-learning model to establish the trained machine-learning model based on a dataset of a plurality of audio segments and corresponding audio segment labels classifying each corresponding audio segment as containing media content or containing no media content, wherein training the machine-learning model comprises:
(i) determining at least one statistical measure of each of at least one audio property of each of the audio segments,
(ii) feeding the at least one statistical measure of each of the audio segments to obtain a prediction of each of the plurality of audio segments contains media content or contains no media content, and
(iii) updating the machine-learning model based on a comparison of the prediction of each of the plurality of audio segments with the corresponding audio segment labels.

7. The method of claim 5, wherein the machine-learning model is trained based on at least one statistical measure of each of at least one audio property, and wherein applying the trained machine-learning model comprises (i) determining the at least one statistical measure of each of the at least one audio property of the received audio and (ii) feeding into the trained machine-learning model the determined at least one statistical measure of each of the at least one audio property of the received audio.

8. The method of claim 7, wherein the at least one audio property comprises a property selected from the group consisting of a spectrogram, a signal-to-noise ratio, and a sound pressure level measurement.

9. The method of claim 8, wherein the at least one statistical measure comprise a statistical measure selected from the group consisting of mean, standard deviation, skewness, and kurtosis.

10. The method of claim 7, wherein the at least one audio property comprises a spectrogram, a signal-to-noise ratio, and a sound pressure level measurement, and the at least one statistical comprises mean, standard deviation, skewness, and kurtosis.

11. A portable computing device comprising:
a microphone;
a processor; and
a non-transitory computer-readable storage medium, having stored thereon program instructions that, upon execution by the processor, cause performance of a set of operations comprising:
receiving, into the microphone of the portable computing device, audio from a surrounding environment of the portable computing device;
classifying the received audio as containing media content or as containing no media content, wherein classifying the received audio as containing media content or as containing no media content comprises determining whether the audio defines content emitted from a media player in the surrounding environment of the portable computing device; and
based on the classifying, controlling whether to engage in an audio-identification process for determining an identity of the media content, wherein the controlling includes (i) if the portable computing device classifies the received audio as containing media content rather than as containing no media content, then engaging in the audio-identification process for determining the identity of the media content, and (ii) if the portable computing device classifies the received audio as containing no media content rather than as containing media content, then forgoing from engaging in the audio-identification process for determining the identity of the received audio.

12. The portable computing device of claim 11, wherein engaging in the audio-identification process for determining the identity of the media content comprises generating digital fingerprint data representing the received audio, wherein the generated digital fingerprint data is useable to facilitate automatic content recognition (ACR).

13. The portable computing device of claim 11, wherein engaging in the audio-identification process for determining the identity of the media content comprises searching in the received audio for watermarking that encodes an identifier of the media content.

14. The portable computing device of claim 11, wherein the audio-identification process facilitates measuring media exposure.

15. The portable computing device of claim 11, wherein classifying the received audio as containing media content or containing no media content comprises applying a trained machine-learning model that classifies the received audio as containing either media content or not containing media content.

16. The portable computing device of claim 15, wherein the machine-learning model is trained based on at least one statistical measure of each of at least one audio property, and wherein applying the trained machine-learning model comprises (i) determining the at least one statistical measure of each of the at least one audio property of the received audio and (ii) feeding into the trained machine-learning model the determined at least one statistical measure of each of the at least one audio property of the received audio.

17. The portable computing device of claim 16, wherein the at least one audio property comprises a property selected from the group consisting of a spectrogram, a signal-to-noise ratio, and a sound pressure level measurement.

18. The portable computing device of claim 17, wherein the at least one statistical measure comprise a statistical measure selected from the group consisting of mean, standard deviation, skewness, and kurtosis.

19. The portable computing device of claim 16, wherein the at least one audio property comprises a spectrogram, a signal-to-noise ratio, and a sound pressure level measurement, and the at least one statistical comprises mean, standard deviation, skewness, and kurtosis.

20. A non-transitory computer-readable storage medium, having stored thereon program instructions that, upon execution by a processor of a portable computing device, cause performance of a set of operations comprising:
receiving, into a microphone of the portable computing device, audio from a surrounding environment of the portable computing device;
classifying the received audio as containing media content or as containing no media content, wherein classifying the received audio as containing media content or as containing no media content comprises determining whether the audio defines content emitted from a media player in the surrounding environment of the portable computing device; and
based on the classifying, controlling whether to engage in an audio-identification process for determining an identity of the media content, wherein the controlling includes (i) if the portable computing device classifies the received audio as containing media content rather than as containing no media content, then engaging in the audio-identification process for determining the identity of the media content, and (ii) if the portable computing device classifies the received audio as containing no media content rather than as containing media content, then forgoing from engaging in the audio-identification process for determining the identity of the received audio.
